(19) United States
(12) Patent Application Publication
(10) Pub. No.: US 2019/0293175 A1
(43) Pub. Date: Sep. 26, 2019

(54) POWER TRANSMISSION DEVICE

(71) Applicant: EXEDY Corporation, Osaka (JP)

(72) Inventor: Keiichi YASUDA, Osaka (JP)

(73) Assignee: EXEDY Corporation

(21) Appl. No.: 16/279,151

(22) Filed: Feb. 19, 2019

(30) Foreign Application Priority Data
Mar. 20, 2018 (JP) 2018-051991

(51) Int. Cl. F16H 61/14; F16H 45/02; F16H 41/30

(52) U.S. Cl. CPC F16H 61/143; F16H 2045/0278; F16H 41/30; F16H 45/02

(57) ABSTRACT

A power transmission device is disclosed. The power transmission device includes a housing, a clutch unit, a heat conducting unit, and a heat conducting unit. The housing includes a wall portion. The housing is rotatably disposed, with the torque from the drive source being transmitted to the housing. The wall portion has a through hole formed therein. The clutch unit includes a friction surface engageable with the housing and disposed opposite to the through hole. The clutch unit is disposed in the housing so as to be rotatable relative to the housing. The heat conducting unit is disposed in the through hole and exposed in the housing. The temperature detecting unit is configured to detect a temperature of the heat conducting unit.

### CROSS-REFERENCE TO RELATED APPLICATIONS

This application claims priority to Japanese Patent Application No. 2018-051991, filed Mar. 20, 2018. The contents of that application are incorporated by reference herein in their entirety.

### TECHNICAL FIELD

The present disclosure relates to a power transmission device.

### BACKGROUND ART

A power transmission device includes a housing that is rotated by a torque from a drive source and a lock-up clutch that is disposed in the housing and relatively rotatable therewith. For example, a torque converter includes a front cover, an impeller, a turbine, and a lock-up clutch. The front cover and the impeller constitute the housing. In an area where the rotational speed per unit time of a drive source (hereinafter simply referred to as “a rotational speed”) is low, the lock-up clutch is in the OFF state, and the torque from the drive source is outputted via the impeller and the turbine. On the other hand, when the rotational speed exceeds a predetermined rotational speed, the lock-up clutch is turned ON and frictionally engages with the front cover. As a result, the torque from the drive source is outputted via the lock-up clutch.

In recent years, a torque converter that performs a so-called slip control in which a lock-up clutch is frictionally engaged while sliding on the front cover or the like has been proposed in order to achieve enhancement of fuel consumption and reduction of noise and vibration. However, a friction member of the lock-up clutch may overheat and be damaged when such slip control is performed. In order to prevent this friction member from being damaged, the area to perform slip control is limited. Obtaining the surface temperature of the friction member is necessary in order to expand the area where slip control is performed. Given this situation, in a torque converter disclosed in Japan Laid-open Patent Application Publication No. 2001-65685, the surface temperature of the friction member is calculated from the oil temperature of the hydraulic fluid.

### BRIEF SUMMARY

In the above described torque converter, the temperature of a friction surface is calculated from the temperature of the hydraulic fluid; however, the temperature of the hydraulic fluid varies depending on various factors, which causes a problem that the temperature of the friction surface calculated from the hydraulic fluid temperature is inaccurate.

An objective of the present disclosure is to provide a power transmission device capable of measuring a temperature closer to the temperature of a friction surface as compared with a conventional power transmission device.

A power transmission device according to an aspect of the present disclosure is configured to transmit a torque from a drive source to a drive wheel. The power transmission device includes a housing, a clutch unit, a heat conducting unit, and a temperature detecting unit. The housing includes a wall portion that has a through hole formed therein. In addition, the housing is rotatably disposed, and the torque from a drive source is transmitted to the housing. The clutch unit is disposed in the housing so as to be rotatable relative with respect thereto. The clutch unit has a friction surface engageable with the housing. The friction surface is arranged opposite to the through hole. The heat conducting unit is disposed in the through hole and is exposed in the housing. The temperature detecting unit detects a temperature of the heat conducting unit.

According to this configuration, because of detecting a temperature of the heat conducting unit provided in the through hole which connects the inside and outside of the housing and is disposed opposite to the friction surface, the influence of thermal diffusion in the housing and thermal diffusion caused by the flow and agitation of the hydraulic oil is reduced, thereby making it possible to measure a temperature closer to the temperature of the friction surface as compared with the conventional one.

Preferably, the clutch unit is disposed movably in a direction in which the friction surface approaches or separates from the wall portion in the housing.

Preferably, the temperature detecting unit is embedded in the heat conducting unit.

Preferably, the heat conducting unit includes a metal plug that is fitted into the through hole to be exposed inside the housing.

Preferably, the heat conducting unit includes a molding material that fills a gap in the through hole.

Preferably, the heat conducting unit includes heat conductive particles contained in the molding material. The heat conductive particles have a thermal conductivity higher than that of the molding material.

Preferably, the molding material and the heat conductive particles are mixed together.

Preferably, the power transmission device further includes a control unit. The control unit controls a driving state of the power transmission device based on a temperature detected by the temperature detecting unit.

Preferably, the control unit controls a driving state of the power transmission device by controlling the clutch unit.

Preferably, in response to an excess of the temperature detected by the temperature detecting unit over a threshold value, the control unit moves the clutch unit to thereby frictionally engage the friction surface with the wall portion.

Preferably, in response to an excess of the temperature detected by the temperature detecting unit over a threshold value, the control unit moves the clutch unit to thereby cause the friction surface to be out of contact with the wall portion.

According to the present disclosure, it is possible to measure a temperature closer to the temperature of the friction surface as compared with a conventional one.

### BRIEF DESCRIPTION OF THE DRAWINGS

FIG. 1 is a cross-sectional view of a power transmission device.

FIG. 2 is an enlarged sectional view of the power transmission device.

FIG. 3 is a flowchart illustrating an operation of a control unit.

### DETAILED DESCRIPTION

Hereinafter, embodiments of a power transmission device according to the present disclosure will be described with reference to the drawings.

### [Overall Configuration]

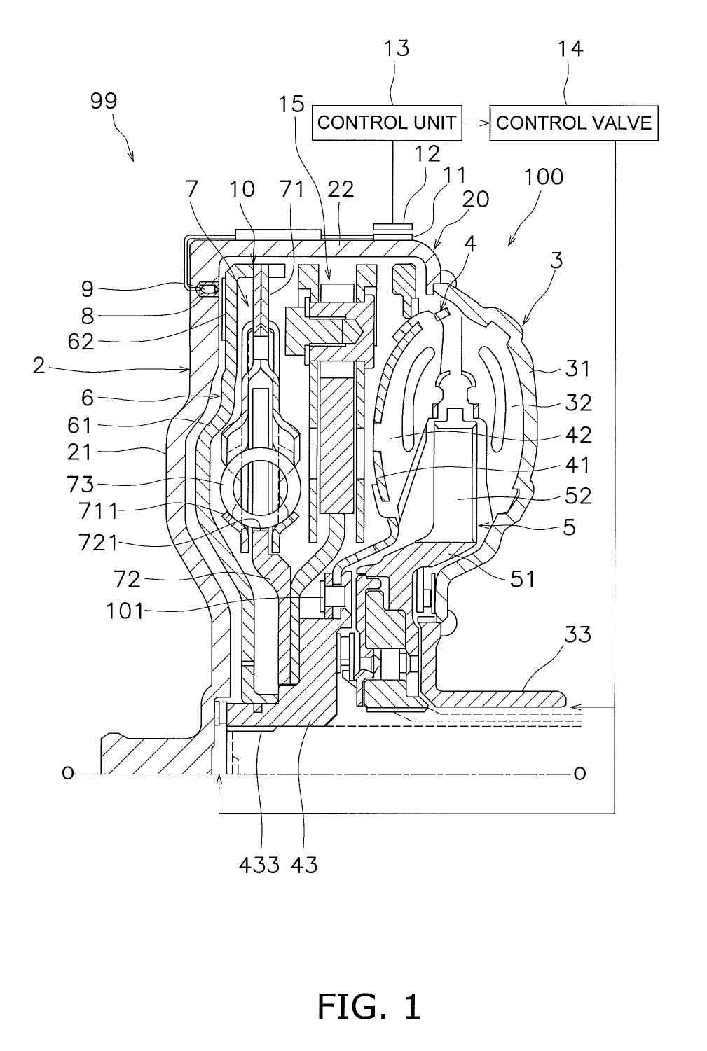

FIG. 1 is a cross-sectional view of a power transmission device 99 according to an embodiment of the present disclosure. The power transmission device 99 includes a torque converter 100. In the following description, the term “axial direction” means an extending direction of a rotational axis O of the torque converter 100. In addition, the term “circumferential direction” refers to a circumferential direction of a circle about the rotational axis O of the torque converter, and the term “radial direction” means a radial direction of a circle about the rotational axis O of the torque converter. The inner side in the radial direction refers to a side approaching the rotational axis O in the radial direction and the outer side in the radial direction refers to a side moving away from the rotational axis O in the radial direction. It should be noted that an engine is disposed on the left side of FIG. 1 whereas a transmission is disposed on the right side of FIG. 1, although the engine and the transmission are not shown in the drawing.

The torque converter 100 is configured to transmit a torque from an engine, which is a drive source, to a drive wheel. The torque converter 100 is rotatable around the rotational axis O. The torque converter 100 includes a front cover 2, an impeller 3, a turbine 4, a stator 5, a lock-up device 10, and a dynamic vibration absorbing device 15. The power transmission device 99 includes the torque converter 100, a heat conducting unit 8, a temperature detecting unit 9, a power receiving unit 11, a power transmitting unit 12, and a control unit 13.

### [Front Cover]

Torque from the engine (an example of a drive source) is inputted to the front cover 2. The front cover 2 includes a disc part 21 and a tubular part 22. The tubular part 22 extends in the axial direction from an outer peripheral end part of the disc part 21 toward the impeller 3.

### [Impeller 3]

The impeller 3 includes an impeller shell 31, a plurality of impeller blades 32, and an impeller hub 33. An outer peripheral end part of the impeller shell 31 is fixed to a front tip part of the tubular part 22 of the front cover 2. For example, the impeller shell 31 is fixed to the front cover 2 by welding.

The impeller blades 32 are fixed to the inner surface of the impeller shell 31. The impeller hub 33 is fixed to the inner peripheral part of the impeller shell 31 by welding or the like.

The impeller shell 31 and the front cover 2 constitute a housing 20 of the torque converter 100. The interior of the housing 20 is filled with fluid. More specifically, the interior of the housing 20 is filled with hydraulic oil. The housing 20 is rotatably disposed and receives the torque transmitted from the engine. The housing 20 has a through hole 211. The through hole 211 is, for example, cylindrical in shape. The through hole 211 communicates the inside and the outside of the housing 20. The through hole 211 is formed in the disc part 21 of the front cover 2. The through hole 211 penetrates the disc part 21 of the front cover 2 in the axial direction. The disc part 21 that has the through hole 211 formed therein corresponds to a wall portion of the present disclosure.

### [Turbine 4]

The turbine 4 is disposed so as to face the impeller 3. The turbine 4 includes a turbine shell 41, a plurality of turbine blades 42, and a turbine hub 43. The turbine blades 42 are fixed to an inner surface of the turbine shell 41 by brazing or the like.

The turbine shell 41 is fixed to the turbine hub 43 by rivets 101. A spline hole 433 is formed in an inner peripheral surface of the turbine hub 43. An input shaft of the transmission is spline-fitted to the spline hole 433.

### [Stator 5]

The stator 5 is configured to rectify the hydraulic fluid that returns from the turbine 4 to the impeller 3. The stator 5 is rotatable around the rotational axis O. The stator 5 includes a stator carrier 51 and a plurality of stator blades 52.

### [Lock-up Device 10]

The lock-up device 10 is configured to mechanically transmit torque from the front cover 2 to the turbine hub 43. The lockup device 10 is disposed between the front cover 2 and the turbine 4 in the axial direction. The lockup device 10 includes a clutch unit 6 and a damper mechanism 7.

The clutch unit 6 includes a piston 61 and a friction member 62. The piston 61 has a disc shape and includes a through hole in the center thereof. The turbine hub 43 extends through the through hole of the piston 61. The outer circumferential surface of the turbine hub 43 and the inner circumferential surface of the piston 61 are sealed to each other.

The piston 61 is disposed so as to be rotatable relative to the housing 20. Furthermore, the piston 61 is disposed so as to be rotatable relative to the turbine hub 43. The piston 61 is disposed movably in the axial direction. More specifically, the piston 61 is slidable on the turbine hub 43 in the axial direction.

The friction member 62 is annular in shape. The friction member 62 is fixed to the piston 61. More specifically, the friction member 62 is fixed to an outer peripheral end part of the piston 61. The friction member 62 is disposed so as to face the through hole 211 formed in the disc part 21 of the front cover 2. That is, the friction member 62 and the through hole 211 oppose each other in the axial direction. It is to be noted that a surface of the friction member 62 that faces the through hole 211 side corresponds to the friction surface of the present disclosure.

Upon moving the clutch unit 6 in the axial direction to the side of the front cover 2 (the left side in FIG. 1), the friction member 62 of the clutch unit 6 comes in contact with the disc part 21 of the front cover 2 and frictionally engages therewith. As a result, the clutch unit 6 is brought into a frictional engagement state and rotates integrally with the front cover 2. Under this frictional engagement state, the torque inputted to the front cover 2 is outputted from the turbine hub 43 via the lock-up device 10.

On the other hand, as the clutch unit 6 moves in the axial direction away from the front cover 2 (the right side in FIG. 1), the friction member 62 of the clutch unit 6 separates from the disc part 21 of the front cover 2 and is no longer in contact with the disc part 21. As a result, the clutch unit 6 is brought into a released state in which the frictional engagement between the friction member 62 and the disc part 21 is released and becomes rotatable relative to the front cover 2. Note that in this released state, the torque inputted to the front cover 2 is outputted from the turbine hub 43 via the impeller 3 and the turbine 4.

In addition, the clutch unit 6 can assume a slip state. In this slip state, while the friction member 62 and the disc part 21 are in contact with each other, the clutch unit 6 is frictionally engaged with a force that is weaker than that in the frictional engagement state. Therefore, the friction member 62 and the disc part 21 are caused to slip while being frictionally engaged. Under the slip state, part of the torque inputted to the front cover 2 is outputted from the turbine hub 43 via the impeller 3 and the turbine 4 while the rest of the torque is outputted from the turbine hub 43 via the lock-up device 10.

The damper mechanism 7 is disposed between the piston 61 and the turbine 4 in the axial direction. The damper mechanism 7 includes a drive plate 71, a driven plate 72, and a plurality of torsion springs 73.

The drive plate 71 is formed in a disc shape, and an outer peripheral end part thereof is engaged with the piston 61. Therefore, the drive plate 71 rotates integrally with the piston 61. Moreover, the drive plate 71 and the piston 61 move relative to each other in the axial direction. The drive plate 71 has a plurality of accommodating parts 711 arranged at intervals in the circumferential direction.

The driven plate 72 is formed in a disc shape. The driven plate 72 is fixed to the turbine hub 43. More specifically, an inner peripheral end part of the driven plate 72 is fixed to the turbine hub 43 by welding or the like. The driven plate 72 has a plurality of accommodating parts 721 arranged at intervals in the circumferential direction. The accommodating parts 721 of the driven plate 72 are disposed so as to overlap with the accommodating parts 711 of the drive plate 71 as viewed in the axial direction.

The torsion springs 73 are housed in the accommodating parts 711 of the drive plate 71 and the accommodating parts 721 of the driven plate 72. The torsion springs 73 elastically couple the drive plate 71 and the driven plate 72.

With the above configuration, the torque inputted to the clutch unit 6 is outputted from the turbine hub 43 via the drive plate 71, the torsion springs 73, and the driven plate 72.

### [Dynamic Vibration Absorbing Device]

The dynamic vibration absorbing device 15 is disposed between the lock-up device 10 and the turbine 4. The dynamic vibration absorbing device 15 is attached to the turbine 4. More specifically, the dynamic vibration absorbing device 15 is attached to the turbine hub 43.

### [Heat Conducting Unit]

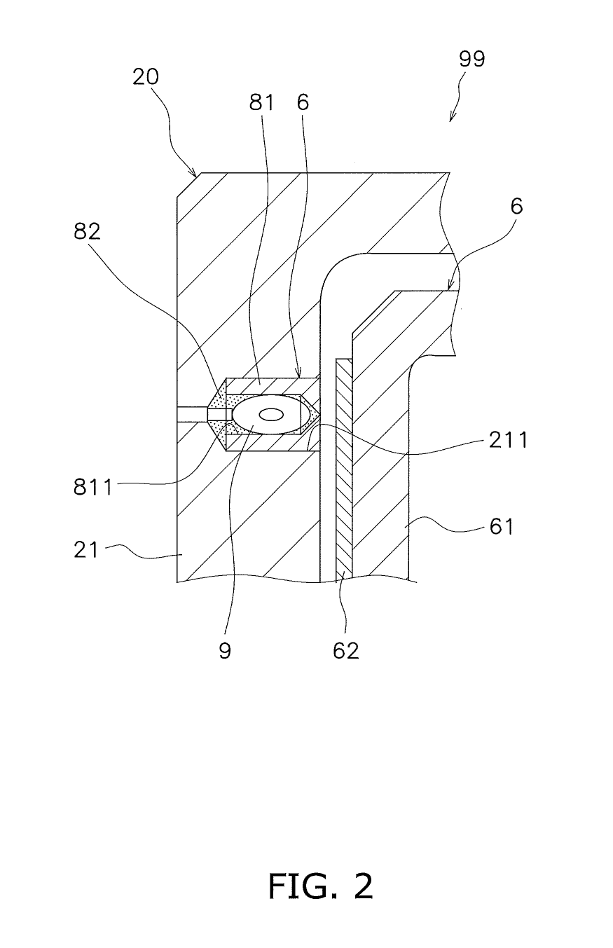

As shown in FIG. 2, the heat conducting unit 8 is disposed inside the through hole 211 formed in the disc part 21 of the front cover 2. The heat conducting unit 8 is exposed in the housing 20. More specifically, the surface of the heat conducting unit 8 that faces the friction member 62 is substantially flush with the inner surface of the disc part 21 without any difference in level.

The heat conducting unit 8 includes a metal plug 81 and a molding material 82. The metal plug 81 is fitted into the through hole 211 so as to close the through hole 211. Specifically, the metal plug 81 is press-fitted into the through hole 211.

The metal plug 81 has a higher thermal conductivity than the front cover 2. For example, the thermal conductivity of the metal plug 81 is preferably 1.5 times or more higher than the thermal conductivity of the front cover 2. When the front cover 2 is made of an iron-based material, the metal plug 81 is preferably 100 w/mK, for example, and can be made of elements such as copper, aluminum, or silver.

The metal plug 81 is cylindrical in shape and has a recess portion 811. The recess portion 811 opens toward the side that is opposite from the friction member 62 (the left side in FIG. 2). A temperature detecting unit 9 is accommodated in the recess portion 811.

The molding material 82 fills a gap in the through hole 211. More specifically, the molding material 82 fills a gap in the recess portion 811 of the metal plug 81 in which the temperature detecting unit 9 is accommodated. Filling the gap with the molding material 82 as described above allows more reliable thermal conductivity to be carried out between the metal plug 81 and the temperature detecting unit 9.

The molding material 82 can be made of, for example, a resin. As the resin constituting the molding material 82, for example, an epoxy resin, a silicone resin, a phenol resin, or the like can be used. In addition, the molding material 82 contains heat conductive particles. The heat conductive particles are dispersed in the molding material 82. The heat conductive particles have a higher thermal conductivity than the resin which constitutes the molding material 82. For example, similarly to the metal plug 81, the thermal conductivity of the heat conductive particles is preferably 1.5 times or more higher than the thermal conductivity of the front cover 2. Thus, the heat conducting unit 8 is configured in this manner by pouring and solidifying the molding material 82 containing the heat conductive particles into the gap in the recess portion 811 of the metal plug 81 in which the temperature detecting unit 9 is accommodated.

### [Temperature Detecting Unit]

The temperature detecting unit 9 is configured to detect the temperature of the heat conducting unit 8. The temperature detecting unit 9 is, for example, a negative characteristic thermistor, and is connected to other elements so as to form a bridge circuit (not shown in the drawing). It should be noted that the temperature detecting unit 9 can be any detecting unit as long as the output changes in response to temperature, and can be a positive characteristic thermistor or a thermocouple.

The temperature detecting unit 9 is embedded in the heat conducting unit 8. More specifically, the temperature detecting unit 9 is accommodated in the recess portion 811 of the metal plug 81. Then, the recess portion 811 is filled with the molding material 82 so as to embed the temperature detecting unit 9 accommodated in the recess portion 811. The temperature detecting unit 9 is wire connected to a power receiving unit 11 by an electric wire or the like.

### [Power Receiving Unit]

As shown in FIG. 1, the power receiving unit 11 is electrically connected to the temperature detecting unit 9. More specifically, the power receiving unit 11 and the temperature detecting unit 9 are wire connected by electric wires or the like. The power receiving unit 11 is attached to the outer peripheral surface of the housing 20. More specifically, the power receiving unit 11 is attached to an outer peripheral surface of the tubular part 22 constituting the outer peripheral wall of the housing 20. The power receiving unit 11 is configured with, for example, a power receiving coil.

### [Power Transmitting Unit]

The power transmitting unit 12 is disposed radially outward of the power receiving unit 11 and spaced apart therefrom. For example, the power transmitting unit 12 can be attached to an inner wall surface of a housing accommodating the torque converter 100. The power transmitting unit 12 is configured to transmit power to the power receiving unit 11 in a non-contact manner. That is, the power transmitting unit 12 transmits power to the power receiving unit 11 by means of wireless power supply. It is to be noted that the wireless power supplying system between the power transmitting unit 12 and the power receiving unit 11 can be a magnetic field coupling system, an electric field coupling system, or an electromagnetic field coupling system. The power transmitting unit 12 is constituted by, for example, a power transmission coil.

### [Control Unit]

The control unit 13 controls a driving state of the torque converter 100 based on the temperature detected by the temperature detecting unit 9. In the present embodiment, the control unit 13 controls the clutch unit 6 as the driving state of the torque converter 100. More specifically, the control unit 13 controls the control valve 14 to control the hydraulic pressure acting on the clutch unit 6 and thereby move the clutch unit 6 in the axial direction.

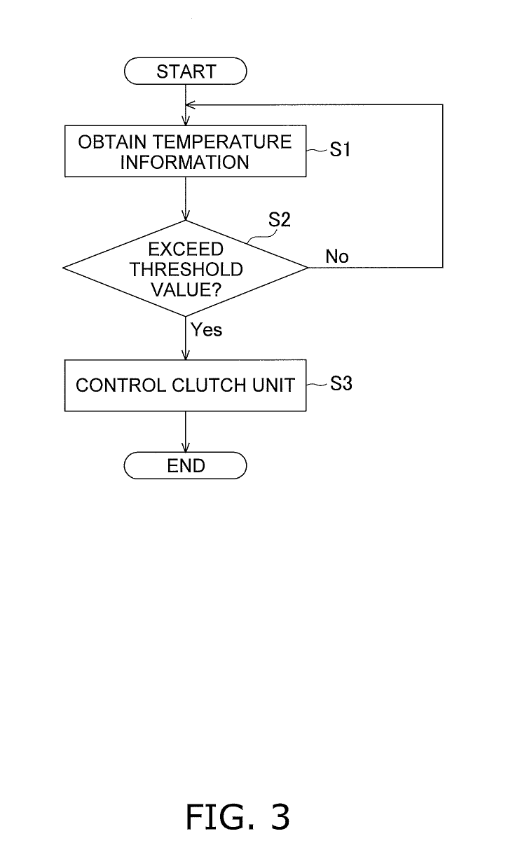

Next, an operation of the control unit 13 will be explained. First, as shown in FIG. 3, the control unit 13 obtains information regarding the temperature detected by the temperature detecting unit 9 by wireless communication (step S1). For this wireless communication, a wireless chip and an antenna (not shown) are provided in the torque converter 100 and an antenna (not shown) is also provided in the control unit 13 to enable the construction of a telemetry system that performs wireless communication of digital modulation method or analog modulation method. Note that this wireless communication can be a load modulation communication method via the power receiving unit 11 and the power transmitting unit 12.

The control unit 13 determines whether or not the temperature detected by the temperature detecting unit 9 exceeds a preset threshold value (step S2). When determination has been made that the temperature detected by the temperature detecting unit 9 does not exceed the threshold value (“No” in step S2), the control unit 13 executes the process of step S1 again.

When determination has been made that the temperature detected by the temperature detecting unit 9 exceeds the threshold value (“Yes” in step S2), the control unit 13 controls the clutch unit 6 (step S3). For example, the control unit 13 causes the clutch unit 6 to move toward the front cover 2 in the axial direction to bring the clutch unit 6 into a friction engagement state. Alternatively, the control unit 13 causes the clutch unit 6 to move in a direction away from the front cover 2 in the axial direction, thereby bringing the clutch unit 6 into a released state. It is to be noted that, preferably, the control executed by the control unit 13 is performed when the clutch unit 6 is in the slip state.

### Example Modifications

An embodiment of the present disclosure has been described above; however, the present disclosure is not limited thereto, and various modifications are possible without departing from the spirit of the present disclosure.

### Example Modification 1

Although the outer peripheral wall portion of the housing 20 is mainly constituted by the tubular part 22 of the front cover 2, the configuration is not particularly limited thereto. For example, the impeller shell 31 can include a disc part and a tubular part like the front cover 2. A configuration can be adopted in which the tubular part of the impeller shell 31 constitutes the outer peripheral wall portion of the housing 20, or the outer peripheral wall portion of the housing 20 can be formed by both the tubular part 22 of the front cover 2 and the tubular part of the impeller shell 31.

### Example Modification 2

In the aforementioned embodiment, the friction surface of the piston 61 faces the axial direction; however, the direction in which the friction surface of the piston 61 faces is not limited to the axial direction. For example, the friction surface of the piston 61 can face outward in the radial direction. Specifically, the friction member 62 can be fixed to an outer peripheral surface of the piston 61. In this case, the piston 61 moves in the radial direction, whereby the friction surface of the piston 61 frictionally engages with the inner peripheral surface of the outer peripheral wall portion of the housing 20. Further, the through hole 211 is formed in the outer peripheral wall portion of the housing 20.

### Example Modification 3

In the aforementioned embodiment, the clutch unit 6 includes the piston 61 and the friction member 62; however, the present disclosure is not limited thereto. For example, a friction surface can be directly formed on the outer peripheral end part of the piston 61.

### Example Modification 4

In the aforementioned embodiment, the control unit 13 controls the clutch unit 6; however, the present disclosure is not limited thereto. For example, the control unit 13 can control the rotational speed of the engine which is the drive source. When it is determined that the threshold value has been exceeded, the control unit 13 can control the engine to thereby reduce the engine speed.

### Example Modification 5

In the aforementioned embodiment, the heat conductive particles are contained in the resin mold member 82, but the configuration of the mold member 82 is not limited thereto. For example, the molding material 82 can be made of metal instead of resin. For instance, the molding material 82 can be made of elements such as copper, aluminum, or silver. In this case, it is not necessary to add the heat conductive particles into the molding material 82. In addition, for example, a configuration can be adopted in which a plurality of heat conductive particles is filled in the recess portion 811 and the molding material 82 is disposed so as to cover the recess portion 811.

### Example Modification 6

In the aforementioned embodiment, the clutch unit 6 is configured so that the friction member 62 directly contacts the housing 20; however, the configuration of the clutch unit 6 is not limited thereto. For example, a configuration can be adopted in which the clutch unit 6 is configured such that the friction surface frictionally engages with another member in a position away from the housing 20 but in the vicinity thereof. Even in that case, it is preferable to provide the through hole 211 in the housing 20 at a position facing the friction surface in the vicinity thereof, and to provide the heat conducting unit 8 and the temperature detecting unit 9 as in the above embodiment.

### REFERENCE SIGNS LIST

6 Clutch part,
8 Heat Conducting Unit
81 Metal Plug
82 Mold Material
9 Temperature Detecting Unit
13 Control unit
20 Housing
211 Through hole

What is claimed is:

1. A power transmission device for transmitting a torque from a drive source to a drive wheel, the power transmission device comprising:
a housing including a wall portion, the housing rotatably disposed, with the torque from the drive source being transmitted to the housing, the wall portion having a through hole formed therein;
a clutch unit including a friction surface engageable with the housing and disposed opposite to the through hole, the clutch unit disposed in the housing so as to be rotatable relative to the housing;
a heat conducting unit disposed in the through hole and exposed in the housing; and
a temperature detecting unit configured to detect a temperature of the heat conducting unit.

2. The power transmission device according to claim 1, wherein
the clutch unit is disposed movably in a direction in which the friction surface approaches or separates from the wall portion in the housing.

3. The power transmission device according to claim 1, wherein
the temperature detecting unit is embedded in the heat conducting unit.

4. The power transmission device according to claim 1, wherein
the heat conducting unit includes a metal plug fitted in the through hole and exposed in the housing.

5. The power transmission device according to claim 1, wherein
the heat conducting unit includes a molding material filling a gap in the through hole.

6. The power transmission device according to claim 5, wherein
the heat conducting unit further includes heat conductive particles, and
the heat conductive particles have a higher thermal conductivity than the molding material.

7. The power transmission device according to claim 6, wherein
the molding material and the heat conductive particles are mixed together.

8. The power transmission device according to claim 1, further comprising
a control unit programmed to control a driving state of the power transmission device based on a temperature detected by the temperature detecting unit.

9. The power transmission device according to claim 8, wherein
the control unit is further programmed to control the driving state of the power transmission device by controlling the clutch unit.

10. The power transmission device according to claim 9, wherein
in response to an excess of the temperature detected by the temperature detecting unit over a threshold value, the control unit is programmed to move the clutch unit to frictionally engage the friction surface with the wall portion.

11. The power transmission device according to claim 9, wherein
in response to an excess of the temperature detected by the temperature detecting unit over a threshold value, the control unit is programmed to move the clutch unit to cause the friction surface to be out of contact with the wall portion.
